(19) United States
(12) Patent Application Publication
(10) Pub. No.: US 2004/0081585 A1
(43) Pub. Date: Apr. 29, 2004

(54) Device and method for measuring urine conductivity

(76) Inventor: Brian Reid, Orangeville (CA)

Correspondence Address: SHAPIRO COHEN, P.O. BOX 3440, STATION D, OTTAWA, ON, K1P6P1, CA

(21) Appl. No.: 10/467,669

(22) PCT Filed: Feb. 21, 2002
(86) PCT No.: PCT/CA02/00213

(30) Foreign Application Priority Data
Feb. 22, 2001 (CA) 2,337,475

(51) Int. Cl. G01N 27/06

(52) U.S. Cl. 422/82.02

(57) ABSTRACT

A system and method for measuring the conductivity level in a urine sample. The system also calculates and displays the electrolyte concentration, and the osmotic pressure. The system further indicates whether or not these levels are low, normal, high or dangerous for the heart. The system comprises a power source, a detection probe for measuring the conductivity level of a given urine sample, and a processing means for calculating and outputting the electrolyte concentration and the osmotic pressure of a urine sample. Such calculations are based on the conductivity level measured in the urine sample. The system also includes a display means for displaying the electrolyte concentration and the osmotic pressure calculated by the processing means.

### FIELD OF INVENTION

This invention relates to a device for indicating a predisposition to heart disease and stroke. Move particularly, this invention relates to a monitoring device for measuring the concentration of electrolytes in a sample of urine.

### BACKGROUND TO THE INVENTION

As preventative health care measures prove to reduce risks of disease and illness, new devices that aid in their prevention are becoming increasingly popular. Monitoring the electrolyte levels in blood and urine can indicate whether body fluid levels are healthy or abnormal.

Body fluids are not just water but are rather a solution containing a number of chemical substances. When a substance such as an electrolyte dissolves in water it becomes separated into its constituent positive and negative particles. These charged particles are called ions and contribute to the ionization of the solutions. In normal health, the electrolyte concentration of various particles remains constant within very narrow limits and a balance will exist between various ions. If for reasons of ill health the balance is upset, then the electrolyte concentration of these ions changes may impose stress on the body and, more importantly, the heart. The electrolyte concentration in a body fluid, such as urine, may be measured. These concentrations are calculated in milimoles of electrolytes per litre.

The present invention seeks to provide a device which will monitor the changes in electrolyte concentration in a urine sample and relate such a measurement to stresses on the heart.

### SUMMARY OF THE INVENTION

The present invention provides a system and method for measuring the conductivity level in a urine sample. The system also calculates and displays the electrolyte concentration, and the osmotic pressure. The system further indicates whether or not these levels are low, normal, high or dangerous for the heart. The system comprises a power source, a detection probe for measuring the conductivity level of a given urine sample, and a processing means for calculating and outputting the electrolyte concentration and the osmotic pressure of a urine sample. Such calculations are based on the conductivity level measured in the urine sample. The system also includes a display means for displaying the electrolyte concentration and the osmotic pressure calculated by the processing means.

In one embodiment of the present invention, the processing means is connected to an interface connector. The interface connector enables the system to transfer data, such as the electrolyte concentration, to a computer system.

In a first aspect, the present invention provides a device for monitoring the blood pressure through a conductivity measurement of a urine sample by a detection probe, the device having processing means for calculating the blood pressure based on the conductivity measurement.

In a second aspect, the present invention provides a device for measuring an electrolyte concentration in a sample of urine, the device including:

a power source;

a detection probe for measuring the conductivity level of a sample of urine, the detection probe receiving power from the power source, the detection probe being inserted into the sample of urine;

a processing means for calculating the electrolyte concentration based on the conductivity level measured by the probe, the processing means being connected to the detection probe and the power source;

a display means for displaying the electrolyte concentration calculated by the processing means, the display means being connected to the processing means and the power source.

In a third aspect, the present invention provides a method for measuring the blood pressure through a conductivity measurement of a urine sample by a detection probe, and calculating the blood pressure based on the conductivity measurement through use of a processing means.

In a fourth aspect, the present invention provides a method for measuring an electrolyte concentration in a sample of urine, the method including the steps of:

(a) applying a voltage to the sample or urine by means of a probe having a power source;

(b) measuring a conductivity level of the sample of urine by means of said probe, based on the voltage applied by the probe in step (a);

(c) reading the conductivity level measured in step (b) through use of a processing means;

(d) storing the conductivity level in memory means;

(e) calculating a value for electrolyte concentration based on the conductivity level retrieved by the processing means in step (c); and

(f) storing in memory means the value for electrolyte concentration.

### BRIEF DESCRIPTION OF THE DRAWINGS

The invention will now be described with reference to the drawings, in which:

FIG. 1 is an illustration of the cardio-health meter according to the present invention;

FIG. 2 is an illustration of a first example of the information displayed by the cardio-health meter at system initialization according to the present invention;

FIG. 3 is an illustration of a second example of the information displayed by the cardio-health meter while in operation according to the present invention;

FIG. 4 is a block diagram of the specialized circuitry for measuring and displaying the electrolyte concentration of a urine sample according to the present invention;

FIG. 5 is a detailed illustration of the detection probe of FIG. 1 according to the present invention;

FIG. 6 is a flowchart detailing the steps in a process for measuring the electrolyte concentration of a urine sample according to the present invention;

FIG. 7 is a flowchart detailing the steps in a subsidiary process of FIG. 6 for outputting the electrolyte concentration to display means according to the present invention; and

FIG. 8 is a flowchart detailing the steps in a subsidiary process of FIG. 6 for outputting the electrolyte concentration to an interface connection according to the present invention.

### DETAILED DESCRIPTION

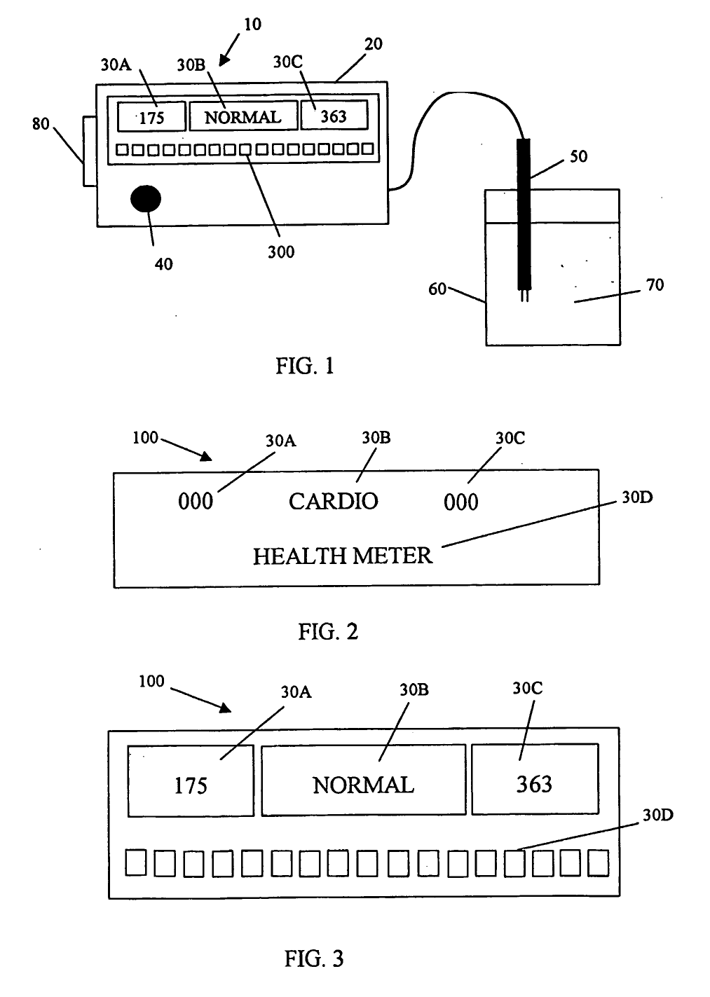

FIG. 1 is a schematic view of a preferred embodiment of the cardio-health meter system 10. The cardio-health meter system 10 shown consists of a casing 20, an LCD display means comprising four separate displays 30A, 30B, 30C, 30D, a push button 40 for operating the system 10, and a detection probe 50. The detection probe 50 is placed in a container 60 of urine sample 70. The system 10 measures the conductivity of the urine sample 70. The casing 20 contains a specialized processor for calculating the conductivity. The specialized circuitry enables the cardio-health meter to calculate and display the electrolyte concentration and the osmotic pressure of the urine sample 70. These calculations are based on the conductivity of the urine sample 70. The container 60 may hold a urine sample 70 of approximately 100 millimeters, but the size of the container chosen and the amount of urine sample 70 required may vary depending on the system design. Based on the electrolyte concentration and the osmotic pressure, the cardio-health meter will indicate whether or not the results are within the normal range. If the results are normal then the hydration level of the user is within an acceptable range. Otherwise, the results may show that the user is placing undue stress on their heart, if the results are above or below the normal range.

In FIG. 1, an interface connection 80, such as a serial interface port connector, is included in the system 10. Although the interface connection 80 is not essential to the system 10, the interface connection 80 enables the system 10 to download the measurements to a computer system or a Personal Digital Assistant (PDA an electronic handheld information device). The interface connection allows the user to track the results on a spreadsheet or table and monitor their electrolyte concentration and osmotic pressure levels.

FIG. 2 illustrates an example of the display means 100 upon activating the cardio-health meter system 10. Although four separate display means 30A, 30B, 30C, 30D are shown, a single display means would suffice. Both display means 30A and 30C are utilized to display the electrolyte concentration and the osmotic pressure respectively of the urine sample 70. The system 10 is initialized by depressing on the push button 40. Upon depression of the push button, the displays means 30A and 30C are reset and a “000” is displayed. At initialization, the display means 30B displays the text message “CARDIO”. The fourth display means 30D, again optional, displays the text message “HEALTH METER”. Both the display means 30B and 30D may display other text messages, in an alternative embodiment of the present invention. The display means 100 may be a Liquid Crystal Display (LCD) commonly known to those skilled in the art of electronics. One or several LCDs may be used in accordance with the present invention to display the electrolyte concentration and/or the osmotic pressure contained in the urine sample.

FIG. 3 illustrates an example of the display means 100 while the system 10 is in operation. The display means 30A displays an example of an electrolyte concentration level calculated by the specialized circuitry. The display means 30B displays a text message “NORMAL” which indicates to the user that the electrolyte concentration, known also as the electrolytic level, is within an acceptable range. Alternatively, the display means 30B might display a text message “DANGER” which would indicate that the electrolyte concentration level is at a dangerous level—a “DANGER” message might indicate stress being on the heart. In a preferred embodiment, four levels are chosen: low, normal, high, and danger. Each of the levels have a predetermined range that is based on the conductivity level of the urine sample 70. The display means 30C displays an example of the osmotic pressure calculated by the processor. The display means 30D is an optional element that displays a bar graph indicating the heart stress level. The heart stress level is based on the conductivity measurement of the urine sample 70. Each level of the bar graph is a predetermined range of conductivity measurements.

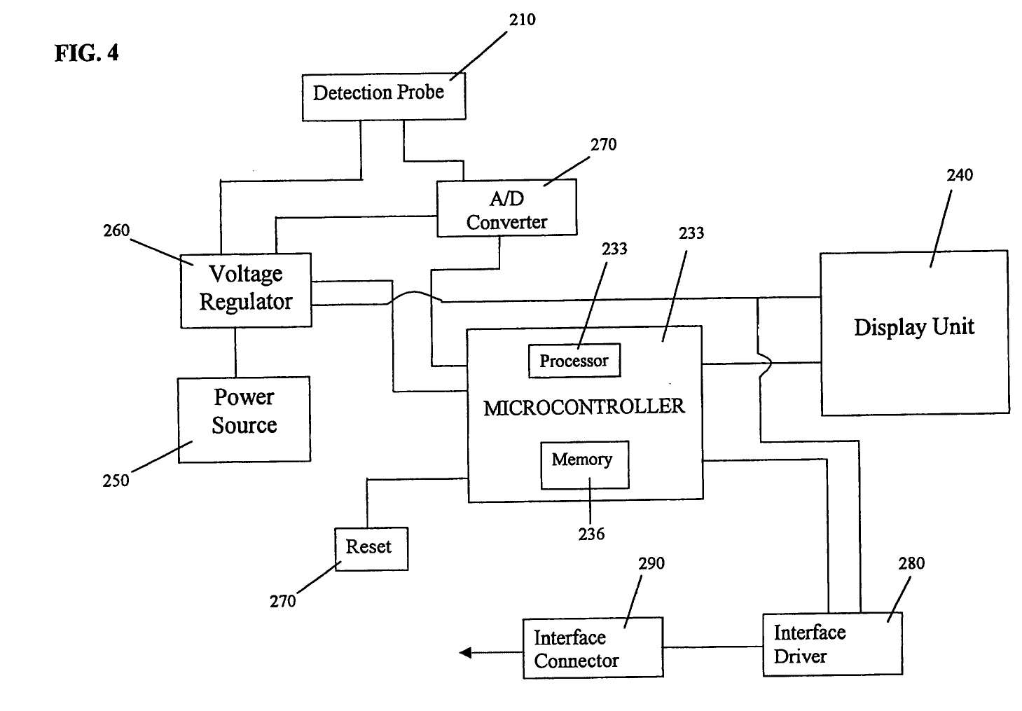

FIG. 4 is a block diagram of the specialized circuitry 200 located in the casing 20 of FIG. 1. The main functional elements of the specialized circuitry are a detection probe 210, a micro-controller 230, a display unit 240, and a power source 250. The power source 250 provides power to the detection probe 210, to the microcontroller, to the display unit, and to other functional elements. It is preferable that power be delivered to these functional elements through use of a voltage regulator 260. For example, a 5 volt voltage regulator is commonly used to power most integrated circuit (IC) chips.

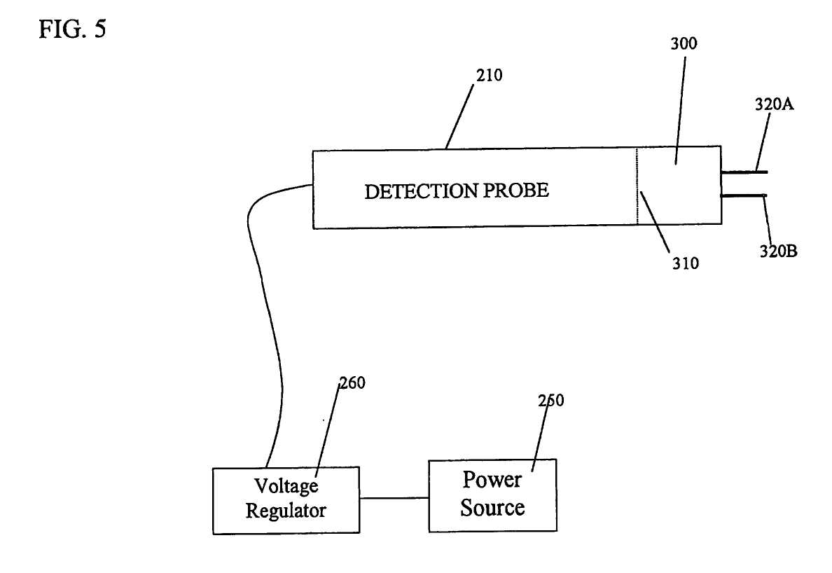

In order to perform the system tests, the detection probe 210 is placed in a container 60 of urine sample 70, as shown in FIG. 1. Further details regarding the detection probe 210 will follow in the description of FIG. 5. While in operation, the detection probe 210 applies a voltage level to the urine sample. A current is produced by the voltage applied at the detection probe. In a preferred embodiment, 5 volts are applied to the urine sample 70. The detection probe is then able to measure the conductivity of the urine sample through a voltage drop reading across the detection probe 210. It should be mentioned that the detection probe 210, utilized by the system, has precision resistance. The precision resistance enables the detection probe 210 to use a precise resistance value in measuring the conductivity (current) of the urine sample 70. The detection probe measurement is based on the Ohm's law equation relating voltage (V) and resistance (R) to current (I), I=V/R. Based on this equation, the detection probe measures the voltage potential across the detection probe 210 and utilizes the resistance value to determine the current applied to the particular urine sample. The voltage drop across the probe is measured. The voltage drop may be converted into a current reading, however, the voltage drop value is preferred according to this embodiment. This particular detection probe has a voltage range of 100 mV to 343 mV. A reading below or above that range would be considered medically impossible, and as such a greater detection range is not required.

The detection probe 210 may be connected directly to the micro-controller 230, or through an analog/digital (A/D) converter 270, as shown in FIG. 4. The A/D converter 270 is utilized to transform an analog measurement of the voltage level into the digital domain. Although many microcontroller chips have a built-in A/D converter, it is assumed that the microcontroller 230 does not. Accordingly, the micro-controller 230 receives a voltage level in the digital domain from the A/D converter. The micro-controller 230 has an internal processing means 233, and an internal memory means 236. The processor 233 is utilized to control the inputting and outputting functions, as well as to calculate the electrolyte concentration and the osmotic pressure. The processor 233 writes and reads data, such as the electrolyte concentration, to and from the memory means 236. The memory means 236 may include both random access memory (RAM) means and read only memory (ROM), however RAM is required.

It should be mentioned that Motorola produces the 68HC705JJ7 8-bit Micro-controller Unit which may be utilized in accordance with the present invention. In combination with the 68HC705JJ7, the system 10 may also utilize a Linear Technology LTC1286 Micropower Sampling 12-bit A/D converter.

Once the detection probe has been placed in a urine sample 70, a push button switch, hereinafter the reset 270, must be depressed. The reset 270 is connected directly to the micro-controller 230. When the reset 270 is activated, the micro-controller 230 resets its internal memory and deletes any previous readings which may have been stored in memory. The reset 270 enables the detection probe to be activated through a signal sent by the processor 233. FIG. 2 is an illustration of the display after the reset has been activated. In FIG. 2, both the display means 30A and 30C have been reset, hence a ‘000’ is shown.

After the reset 270 has been activated, the micro-controller 230 begins the measuring process. After a predetermined time delay, the micro-controller 230 will read a value for the voltage drop across the detection probe 210 via the A/D converter 270. According to a preferred embodiment, the voltage drop is read within a range of 100 mV to 343 mV. Again, a voltage reading below or above that range would be considered physically impossible. The processor 230 reads in the voltage drop value and stores a copy of the value in the memory means 230. The processor then follows the method of calculating the electrolyte concentration based on the voltage drop measured. Certain formulas are required to calculate the electrolyte concentration and are explained through the following example.

Ex: voltage drop value (v) measured by the detection probe: 177 millivolts

Based on the fact that the concentration of electrolytes is equal to the voltage measured in the urine sample.

Electrolyte concentration: 177 millivolts=177 millimoles (mMols)

The 177 millimoles is the electrolyte concentration.

It should be mentioned that the urine sample is comprised of Urea.

The molecular breakdown of Urea is NaHCO₃HCl. The urine sample is comprised of two ionic components Na⁺ (Sodium) and Cl⁻ (Chloride) which are capable of conducting current.

Osmotic pressure is calculated based on a 1 mol (for Na⁺) plus 1 mol (for Cl⁻) multiplied by 177 millimoles.

Osmotic pressure: 2 mol*177 mMols=354 mOsmols

To calculate the blood pressure, the processor 233 uses a known medical multiplier of 19.33, and the osmotic pressure previously calculated, to obtain the hydrostatic pressure.

Hydrostatic pressure: 354 mOsmols*19.33=6843 mm HG

Based on known medical and scientific principles, the hydrostatic pressure may be related to the hydraulic pressure, also known as the blood pressure.

The Hydrostatic pressure is related to the Hydraulic pressure by a ratio of 51.72.

Hydraulic pressure: 6843 mm HG/51.72=132 mm HG

Therefore the blood pressure is 132 mm HG.

According to the preferred embodiment, the electrolyte concentration and the osmotic pressure is displayed rather than the blood pressure. However, the blood pressure may be calculated by the processor and displayed to allow the user to monitor their blood pressure level as well. Again, it should be mentioned that a user is gauging these levels based on the conductivity level of their urine sample.

To further illustrate the levels, calculations are required by the processor 233 to divide the voltage readings into various levels on a bar graph. The bar graph is displayed on display means 30C. The bar graph enables the user to have a graphical representation of their readings. A low-level reading on the bar graph would indicate to the user that their reading is normal. A very high-level reading on the bar graph would indicate to the user that their reading is too high. Finally, a mid to high-level reading on the bar graph would indicate to the user that their reading is high or dangerous. In a preferred embodiment, the display means utilized 16 characters and as such 16 levels may displayed in the bar graph. Accordingly, the voltage range of 100 mV-343 mV is divided into 16 levels. Each range is approximately 15 mV. For example, a voltage of 177 mV would display the first 5 levels out of 16 on the bar graph. The fifth level on the bar graph is considered to be in a normal range.

After all the calculations have been performed, the processor 233 stores a copy of these values determined in the memory means 236. Both the electrolyte concentration and the osmotic pressure are output to the display unit 24. The electrolyte concentration is displayed on the display means 30A and the osmotic pressure is displayed on the display means 30C. Furthermore, the processor determines what indication should be associated with the electrolyte concentration. If the electrolyte concentration is below 149, then processor will output to the display unit data containing the text message “LOW”. If the electrolyte concentration is between 150 and 199, then processor will output to the display unit data containing the text message “NORMAL”. If the electrolyte concentration is between 200 and 240, then the processor 233 will output to the display unit data containing the text message “HIGH”. If the electrolyte concentration is above 240, then the processor 233 will output to the display unit data containing the text message “DANGER”. The display unit 240 outputs the text message received by the processor 233 onto the display means 30B.

The processor 233 outputs a value to the display unit 240 which contains the number of bars to be displayed in the bar graph. The display unit receives this value and illuminates the corresponding number of characters in the display means 30D. The bar graph is a graphical representation of the electrolyte concentration in the urine sample 70.

With regard to the display unit 240, Hitachi produces a LM016L display unit which has 16 character×2 lines display capability. The LM016L would be sufficient for the purposes of the present invention, however, a display unit having fewer or more characters would also be acceptable depending on the specific system design. The system end user may be satisfied with an indication of his/her electrolyte concentration, or may be knowledgeable enough to deduce the stresses that may be placed on the heart from a low or high electrolyte concentration. As such, most types of display units may be utilized in accordance with the present invention.

In an alternative embodiment, the microcontroller 230 is connected to an interface connection which includes an interface driver 280 and an interface connector 290, as shown in FIG. 4. The micro-controller 230 outputs data that is both measured by the detection probe 210, such as the voltage drop reading, and calculated by the processor 233, such as the osmotic pressure, to the interface driver 280. The interface driver will output the data received by the micro-controller to the interface connector 290. The interface connector is then connected either through cables or wireless means, such as infra-red to another system. It may be useful to store the results obtained in a spreadsheet on a computer system. For example, a spreadsheet, such as Microsoft™ Excel, would produce a graph showing the change in electrolytic concentration over time. Depending on the type of interface connector 290 chosen, the data may be output through a serial port or a parallel port, depending on the system design. The interface driver 280 and the interface connector 290 may be a single integrated circuit (IC) chip based on the specific design of the present invention.

FIG. 5 further illustrates the detection probe 210 connected to the voltage regulator 260 and power source 250. The connection 300 represents the two conductive wires for both positive (+) and negative (−) charges. The voltage regulator 260 sends a current to the probe 210 through the connection 300. The power source 250 is preferably a battery to provide added mobility to the user.

The detection probe 210 has an exterior body preferably made of plastic, or other similar non-conductive material. The detection end 300 of the probe is inserted into the urine sample 70. A dashed line 310 illustrates the recommended level of insertion. At the detection end 300, there are two electrodes shown, 320A and 320B. The electrode 320A is known as the reference electrode whereby a voltage is applied to the urine sample. The electrode 320B is known as the working electrode whereby a voltage drop in the urine sample is measured. The pair of electrodes 320A and 320B are inserted into the urine sample 70 and accordingly, the reference electrode 320A applies a voltage to the urine sample 70. The working electrode 320B then measures a voltage drop in the urine sample due to the conduction of ions in the urine sample. It should be noted that the working electrode 320B has a precision resistance connected in series with ground. The working electrode 320B measures the voltage potential which forms across the resistance due to the current flow of the ions in the urine sample. The electrodes 320A and 320B and conductive wiring may be any conductive material. Preferably though, the conductive material should be made of materials such as gold, platinum, silver, or titanium.

The application of approximately 5 volts is preferable for measuring the electrolyte concentration in a urine sample. If, for example, 5 volts are applied to the urine sample and the working electrode measures a voltage drop of 0.275 mV then the reference electrode should have a an equivalent drop in voltage. The reference electrode would have a voltage reading of 4.725 V. The voltage drop of 0.275 mV is an indication of the conductivity level of the urine sample.

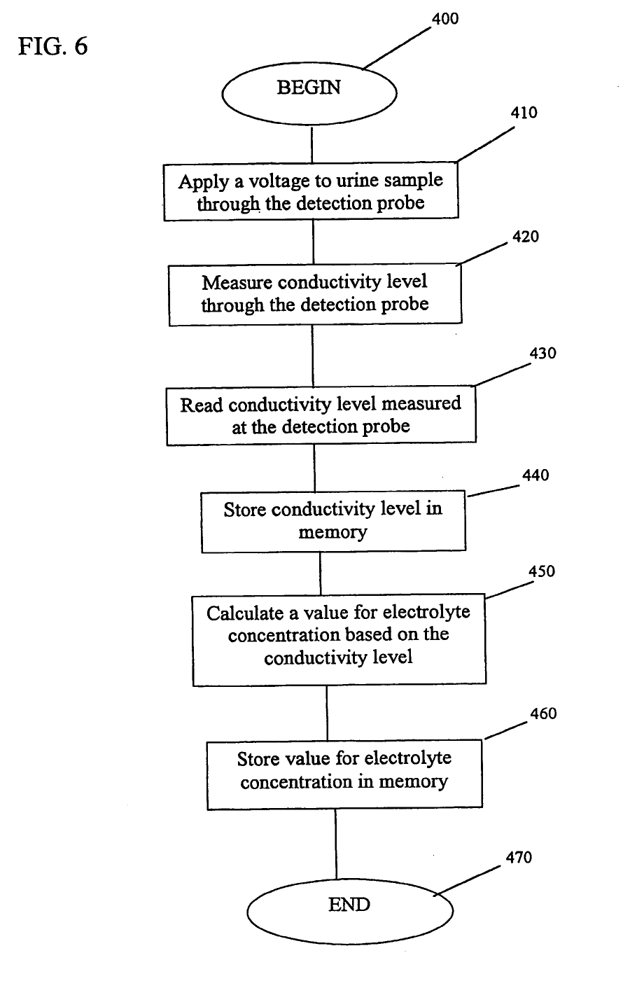

FIG. 6 is a flowchart detailing the steps in a process for measuring and outputting the electrolyte concentration of a urine sample. The process begins at step 400 and is followed by step 410 which entails sending a signal to the detection probe from the processor to instruct the detection probe to apply a voltage to the urine sample. In a next step 420, the detection probe measures the conductivity level in the urine sample, recorded as a voltage level. The processor then reads the voltage value for the conductivity level measured in step 430. After reading the conductivity level, the processor stores the conductivity level in memory in step 440. In a further step, the processor calculates a value for the electrolyte concentration based on the conductivity level read in step 420. As explained previously, the voltage level measured in step 420 is the electrolyte concentration in millimoles. If a 177 millivolts are recorded, then a 177 millimoles is the electrolyte concentration of the urine sample. Next, the electrolyte concentration, calculated in step 450, is stored in memory according to step 460. Finally, the process ends in step 470. It should be noted that the steps detailed in FIG. 6 may be applied to calculating and displaying other measurements such as, osmotic pressure.

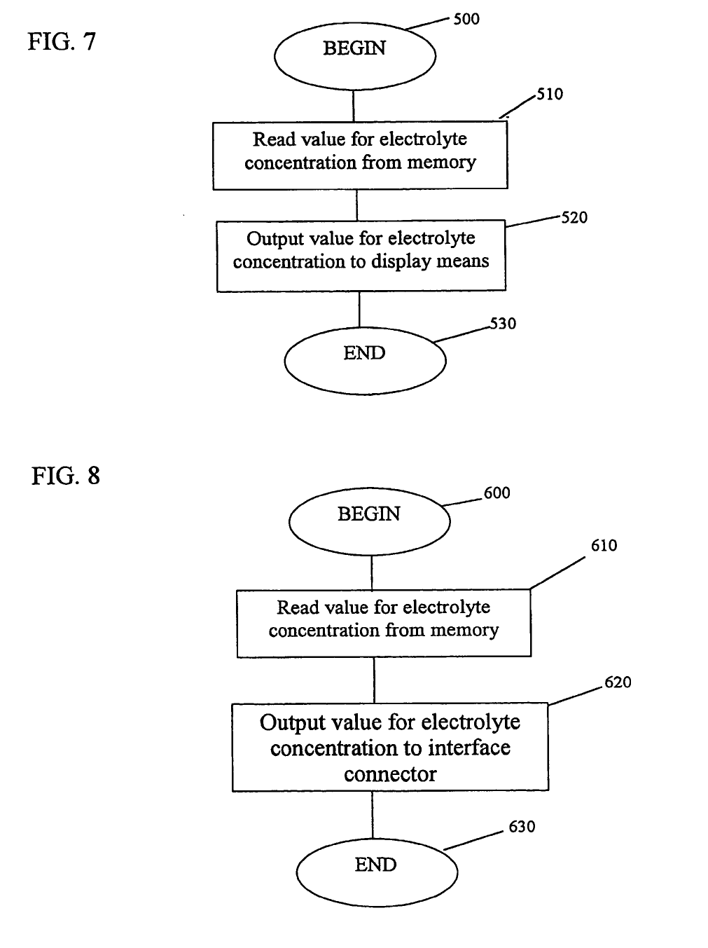

FIG. 7 is a flowchart detailing the steps in a subsidiary process of FIG. 6 for outputting the electrolyte concentration to a display unit. The process begins at step 500 and is followed by a step 510 whereby the processor reads the value for electrolyte concentration from memory. In a further step 520, the processor outputs the value for electrolyte concentration to the display means. The subsidiary process ends in step 530. In a further step, the display means would display the electrolyte concentration accordingly.

FIG. 8 is a flowchart detailing the steps in a subsidiary process of FIG. 6 for outputting the electrolyte concentration to an interface connection. The process begins at step 600 and is followed by a step 610 the processor reading the value for electrolyte concentration from memory. In a further step 620, the processor outputs the value for electrolyte concentration to an interface connection. The subsidiary process ends in step 630. Once the value is output to the interface connector it may be transmitted to a remote system.

It may be conceivable that an implementation of the present invention would incorporate either the subsidiary process of FIG. 7 or of FIG. 8, or both subsidiary processes depending on the system design. Both subsidiary process of FIG. 7 and of FIG. 8 may be applied to display and transmit values for osmotic pressure and hydraulic pressure, known also as blood pressure.

What is claimed is:

1. A device for monitoring the blood pressure through a conductivity measurement of a urine sample by a detection probe, and the device having processing means for calculating the blood pressure based on the conductivity measurement.

2. A device for measuring an electrolyte concentration in a sample of urine, the device including:
a power source;
a detection probe for measuring a conductivity level of the sample of urine, the detection probe receiving power from the power source, the detection probe being inserted into the sample of urine;
a processing means for calculating the electrolyte concentration based on the conductivity level measured by the probe, the processing means connected to the detection probe and the power source;
a display means for outputting the electrolyte concentration calculated by the processing means, the display means connected to the processing means and the power source.

3. A method for measuring the blood pressure through a conductivity measurement of a urine sample by a detection probe, and calculating the blood pressure based on the conductivity measurement through use of a processing means.

4. A method for measuring an electrolyte concentration in a sample of urine, the method including the steps of:
(a) applying a voltage to the sample or urine by means of a probe having a power source;
(b) measuring a conductivity level of the sample of urine by means of a probe, based on the voltage applied by the probe in step (a);
(c) reading the conductivity level measured in step (b) through use of a processing means;
(d) storing the conductivity level in memory means;
(e) calculating a value for electrolyte concentration based on the conductivity level retrieved by the processing means in step (c); and
(f) storing in memory means the value for electrolyte concentration.

5. A method as defined in claim 4, further including the step of outputting to a display means the value calculated in step (d) for displaying the value for electrolyte concentration onto the display means.

6. A method as defined in claim 4, further including the step of outputting the value calculated in step (d) to an interface connection for eventual transmission to a remote system.

7. A method as defined in claim 6, wherein the interface connection is a serial interface connector.

8. A method as defined in claim 6, wherein the interface connector is an infra-red interface connector.

9. A method as defined in claim 6, wherein the interface connection is a parallel interface connector.

10. A method as defined in claim 4, further including the step of calculating an osmotic pressure based on the conductivity level retrieved by the processing means.

11. A method as defined in claim 4, further including the step of calculating an osmotic pressure based on the electrolyte concentration calculated by the processing means.

12. A method as defined in claim 10, further including the step of calculating a hydrstatic pressure based on the osmotic pressure calculated by the processing means.

13. A method as defined in claim 11, further including the step of calculating a hydraulic pressure based on the hydrostatic pressure calculated by the processing means.

14. A method as defined in claim 11, further including the step of calculating a blood pressure based on the hydrostatic pressure calculated by the processing means.

15. A method as defined in claim 11, outputting to a display means a value for osmotic pressure, and displaying the value for osmotic pressure onto the display means.
